(19) United States
(12) Patent Application Publication
(10) Pub. No.: US 2016/0078173 A1
(43) Pub. Date: Mar. 17, 2016

(54) METHOD FOR EDITING DATA AND ASSOCIATED DATA PROCESSING SYSTEM OR DATA PROCESSING SYSTEM ASSEMBLY

(71) Applicant: SIEMENS AKTIENGESELLSCHAFT, München (DE)

(72) Inventors: Sebastian Dippl, München (DE); Albert Eckert, Ingolstadt (DE); Michael Jäger, München (DE)

(21) Appl. No.: 14/785,181

(22) PCT Filed: Feb. 6, 2014
(86) PCT No.: PCT/EP2014/052295

§ 371 Date: Oct. 16, 2015

(30) Foreign Application Priority Data
Apr. 16, 2013 (DE) 10 2013 206 754.2

(51) Int. Cl. G06F 19/00; H04N 1/00; G06T 7/00

(52) U.S. Cl. CPC G06F 19/321; G06T 7/0085; H04N 1/00005; G06T 2207/10004

(57) ABSTRACT

An explanation is given of, inter alia, a method for editing data (BD), comprising: storing (26, 28) at least one rule (R1, R2) in which at least one data editing function is specified and/or which concerns at least one data editing function, transmitting at least one message (30) from a first data processing system (12) to a second data processing system (14), depending on the message (30) using the stored rule (R1, R2), determining (38) at least one data editing function, performing (46) the data editing function for at least one data set specified in the message (30) or for at least one data set determined when the data editing function is called.

The invention relates in particular to a PACS (Picture Archiving and Communication System). Systems of this type are available from various manufacturers for the effective acquisition and storage of the data volumes generated, for example, in the health care sector. The data volumes are particularly large due to the acquired image data, e.g. greater the 1 terabyte in relation to one hospital and one year. However, large image data volumes occur not only in the healthcare sector but also in other areas, such as cartographic services, social networks and like.

The editing of the image data with image editing programs or with image editing functions and/or the editing of other data with other data editing functions can be separated from the storage of the data. However, this may result, for example, in an increase in the data volumes to be transmitted via data transmission networks and/or in a complex maintenance of the data editing functions.

The invention relates to a method for editing, for example, image data or measurement value data, comprising:
storing at least one rule in which at least one data editing function is specified and/or which relates to at least one data editing function,
transmitting at least one message from a first data processing system to a second data processing system,
depending on the message using the stored rule, determining at least one data editing function,
performing the data editing function for at least one dataset specified in the message or for at least
   one dataset determined when the data editing function is performed.

The invention furthermore relates to a data processing system or a data processing system assembly, in particular for carrying out the method as claimed in one of the preceding claims, comprising:
a data editing unit integrated into a picture archiving unit,
and a control unit which has access to rules in which the condition is specified under which at least one editing function is to be carried out depending on additional image data or additional measurement value data, or which specifies a data editing function depending on an identifier which has been defined for a dataset or for a data object.

The object of developments is to indicate simple methods for editing image data, measurement value data and/or additional data which, in particular, reduce the volume of the data to be transmitted and/or the maintenance complexity of data editing functions and/or offer further advantages. Furthermore, an associated data processing system or an associated data processing system assembly is to be specified.

One method for editing data may comprise:
storing at least one rule in which at least one data editing function is specified and/or which relates to at least one data editing function,
transmitting at least one message from a first data processing system to a second data processing system,
depending on the message using the stored rule, determining at least one data editing function,
performing the data editing function for at least one dataset specified in the message or for at least one dataset determined when the data editing function is performed.

The dataset may, in particular, be a data object which has been implemented according to a predefined class definition.

The method is, in particular, carried out automatically. The DP systems in each case contain a processor which executes program commands that are stored in an electronic memory.

The technical effects of the method consist, in particular, in that
the data editing function can be performed on the side of or in close proximity to the data store, and/or
the data editing function can be modified centrally in a simple manner.

Further technical effects can be found in the detailed descriptions of the general method given below.

A method for editing image data may comprise:
storing at least one rule which specifies at least one image editing function, a measurement value editing function or an additional data editing function depending on additional image data or additional measurement value data,
transmitting image data or measurement value data from a first data processing system to a second data processing system,
jointly with the image data, transmitting additional image data or, jointly with the measurement value data, transmitting additional measurement value data,
determining at least one data editing function for the transmitted data using the stored rule,
performing the data editing function for the transmitted data, and
storing the edited data.

The image data may be:
in particular medical image data, i.e. images of body organs, such as the heart, kidney, liver, intestine, stomach, brain, lung, etc., of bone, or bone tissue,
radiology or x-ray, in particular CAT (Computed Axial Tomography) images,
nuclear medicine images,
magnetic resonance tomography (MRT) images,
magnetic resonance images,
computer tomography (CT) images,
endoscopy, cardiology, pathology or microbiology images,
the images may, however, also originate from non-medical areas, e.g. aerial images or satellite images of the Earth's surface, images in digital social networks, etc.

The image editing function may be related:
to one image only, e.g. to the image with which the image data or additional image data are associated,
to a plurality of images, e.g. the same patient and, where appropriate, also the same organ and, where appropriate, also the same image type.

The data editing function may be an image editing function. The image editing function may, in particular, be:
a comparatively simple function, such as automatic filtering, automatic edge detection, automatic outline detection, automatic skeletonization, etc.,
or a more complex function such as CBIR (Content Based Image Retrieval), wherein textual metadata or additional data are generated through image analysis methods,
a function based, for example, on neural networks, fuzzy technologies or knowledge-based systems, i.e., in particular, with learning methods and/or with methods with parallel processing.

The additional image data may be stored, for example, according to the widely used DICOM (Digital Imaging and Communications in Medicine) format or EXIF (Exchangeable Image File) format. The additional image data may describe the image content in words and/or may specify the circumstances of the image recording. Furthermore, for example, the name of the patient or an identifier for the patient may be included. The name or an identifier for a recorded organ/bone or tissue may also be included in the additional image data.

“Transmitted jointly” means that the data are transmitted in the same message or in a plurality of messages which, for example, have a common identifier or have a different relationship known to the recipient, e.g. are transmitted in immediate succession or with little time delay.

The aforementioned method may, in particular, be used for image editing functions that can be performed with comparatively little processing effort, and/or for image data for which it is established that they will be retrieved or read again in the foreseeable future. Format conversions, for example, can be carried out with comparatively little processing effort. Image editing functions which improve the storage can also be used.

The measurement value data may be medical measurement value data, in particular the measurement value series generated by medical devices, e.g. ECG, EEG, etc. The editing function for editing the measurement value data may be a filter function, a function for determining specific features or a different function.

The editing function may, however, also relate to the additional image data or the additional measurement value data.

The rule may contain a condition part (IF) or an action part (THEN) specifying what applies if the condition of the rule is fulfilled. Logical link operators can be used which, for example, link a plurality of conditions, for example AND, OR, XOR or NOT operators. The action part may specify one action or one or more actions. In an alternative described below with specification of a function in a request message, the rule can also be evaluated inversely, i.e., starting from the action, conditions or a condition to be fulfilled by a data object can be determined, so that the function specified in the action part can be performed.

The storing of the rule enables a separation of functions for transmitting image data and functions for editing image data. No image editing function thus needs to be specified in the transmission of the image data or after the transmission of the image data.

The technical effects of this method may consist in that:
the image editing or an editing of other data can be carried out at times when sufficient processing capacity is available, e.g. at night, i.e. largely independently from the time of transmission, and/or
the edited images, the edited measurement values or the edited additional data can later be retrieved immediately, for example with an access time of less than 10 seconds or less than 1 second, since the image editing already takes place before the retrieval, and/or
when the image data or other data are transmitted or recorded, apart from the additional image data or other additional data, no separate specifications for the image editing functions to be performed or a different data editing function are required, which saves input time and considerably simplifies the operation, for both unskilled personnel and qualified personnel.

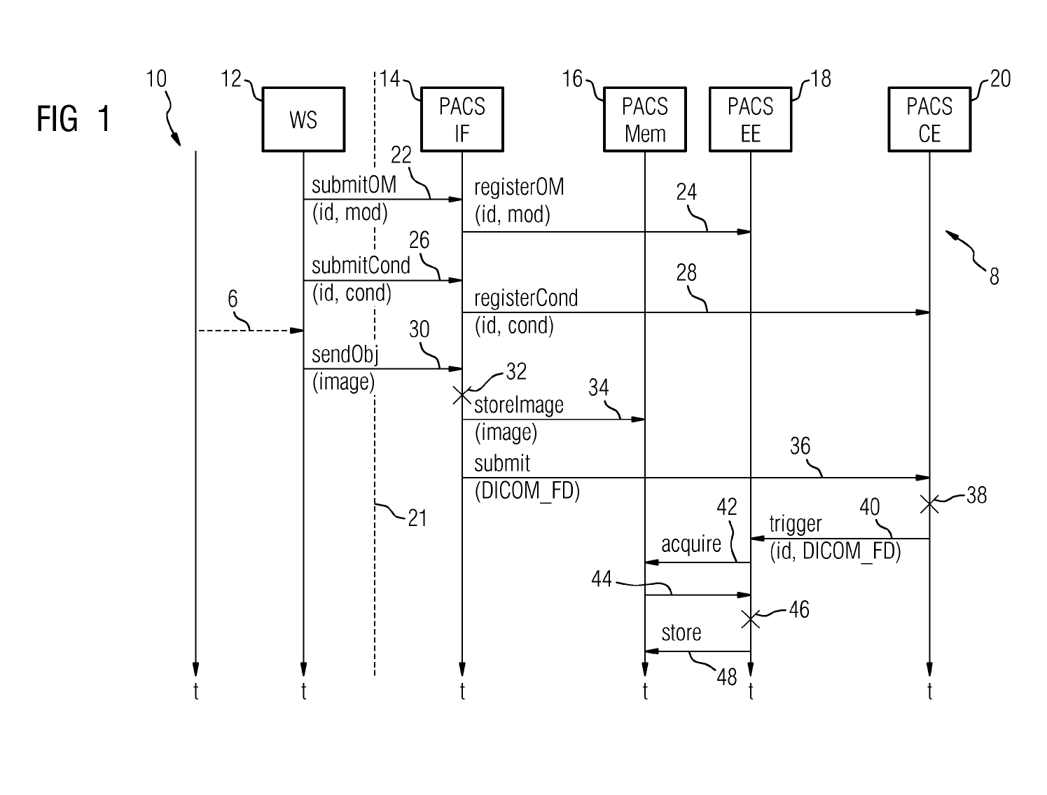

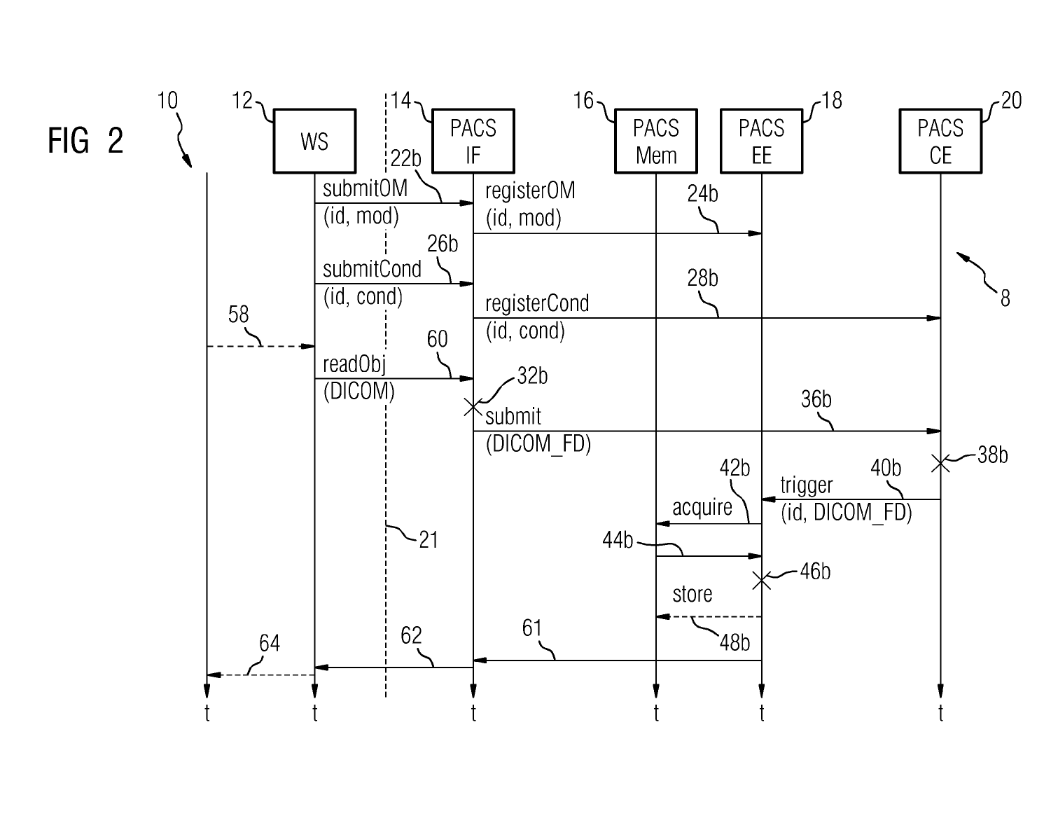

An API (Application Programming Interface) may be present in the data editing unit which forms part of a picture archiving system. This API can be controlled automatically on the basis of the additional image data or the additional measurement value data and predefined rules. An upstream interface can thus be used as the API, which is integrated into the automatic control and, for example, transmits messages to a control unit, as explained in further detail below with reference to FIGS. 1 and 2.

In particular, it is also simply possible by means of the method to perform the image editing or a different data editing on the side of the second data processing system, in particular in close physical proximity, i.e. at a distance of less than 100 meters or less than 10 meters. The first data processing system can thus be of simple design. Moreover, the technical effects specified below can be achieved, for example in terms of a simple maintenance of the first or second data processing system (DP system) and/or the image editing functions integrated into a PACS (Picture Archiving and Communication System) or a different data editing function integrated into a PACS (measurement value data, additional data), in terms of the avoidance of unnecessary transport of image data, etc.

A further method for editing image data and/or measurement value data may comprise:
storing at least one rule which specifies at least one image editing function depending on additional image data or at least one measurement value editing function depending on additional measurement value data,
transmitting a request message for image data or measurement value data from a first data processing system to a second data processing system,
reading of additional data that have been stored for the data requested in the request message or accessing additional image
   data or additional measurement value data contained in the request message, —determining at least one data editing function for the read additional data or for the received additional image data using the stored rule,
performing the data editing function for the image data requested in the request message,
when the data editing function is performed, reading the data requested in the request message from a data store, in particular from an image data store and/or measurement value data store, and
transmitting the edited data to the first data processing system.

The additional image data may be stored in an image data store or in a different DP system (data processing system), i.e. separately from the image data. The additional measurement value data can also be stored in the or in an image data store or in a different DP system, i.e. separately from the measurement value data.

The method can be used in particular if incoming image data or measurement value data are not initially edited, but are only stored together with the associated additional image data or additional measurement value data. On the other hand, some of the editing functions can be performed during the storage and others only during the reading.

The statements made above apply to the image data, the image editing function, the additional image data, the measurement value data, the additional measurement value data, the data editing function, the joint transmission and the rules.

The method using the request message can be employed, in particular, for image editing functions or measurement value editing functions which have to be performed with comparatively substantial computing effort, and/or for image data or measurement value data for which it is established that they will in any case be required again, e.g. immediately, within a specific period or e.g. on the next day.

The storage of the rule enables a separation of functions for requesting data and functions for editing data. No data editing function therefore needs to be specified when the data requested or after the data have been requested.

The technical effects of this method may consist in that:
the editing is performed only if the data are also requested, i.e. no unnecessary editing is performed, in particular with editing functions requiring substantial processing time, and/or
when the request is transmitted, apart from the additional data or apart from an identifier for determining the additional data, no separate specifications are required for the editing functions that are to be performed, which saves input time and considerably simplifies the operation, for both unskilled personnel and qualified personnel.

An API (Application Programming Interface) may be present in the image editing unit or in a different data editing unit which forms part of a picture archiving system. This API can be controlled automatically on the basis of the additional image data or other additional data and predefined rules. An upstream interface can thus be used as the API, which is integrated into the automatic control and, for example, transmits messages to a control unit, as explained in further detail below with reference to FIGS. 1 and 2.

In particular, it is also simply possible by means of the method to perform the image editing or a different data editing on the side of the second data processing system, in particular in close physical proximity, i.e., for example, at a distance of less than 100 meters or less than 10 meters. The first data processing system can thus be of simple design. Moreover, the technical effects specified below can be achieved, for example in terms of a simple maintenance of the first or second DP system and/or the image editing functions integrated into a PACS (Picture archiving and Communication System) or other data editing functions, in terms of the avoidance of unnecessary transport of image data or other data, etc.

The image editing function and, where appropriate, other data editing functions also can be performed in a picture archiving unit into which at least one image editing unit is preferably integrated.

A component of the image editing unit or the measurement value editing unit may therefore be present on the first DP system, in particular a user interface (UI). The API of the image editing unit is used if the IEU (image editing unit) accesses the PAU (picture archiving unit) via the latter's API. However, a different component of the image editing unit is located, for example, on the second DP system or on another DP system which is different from the first DP system. However, all components of the data processing unit may also be located on one DP system or on a plurality of DP systems that are different from the first DP system.

The picture archiving units are known, for example, by the name of PACS, see e.g. the syngo.plaza system from SIEMENS AG. The picture archiving unit may support the DICOM standard.

The storage may comprise the storage of at least one rule which specifies a data editing function depending on an identifier which has been defined for a dataset or for a data object. The message may contain the identifier which specifies the data editing function. When the data editing function is performed, the image data of at least one image and/or the additional image data and/or the measurement value data and/or the additional measurement value data can be determined, in particular data to which the data editing function specified in the message is applicable. When the data editing function is performed, the data editing function can then be applied to the determined data.

Additional data specified in the message can be used when the data are determined.

An additional query facility or selection facility is therefore created. In particular, no new definitions are required for the message in order to specify a function directly in the message, since the function is defined indirectly via a rule.

The method with specification of the editing function in the message can also be used in particular if incoming image data or measurement value data are not initially edited, but are only stored together with the associated additional image data or additional measurement value data. On the other hand, some of the editing functions can be performed during the storage and others only during the reading.

The statements made above apply to the image data, the image editing function, the additional image data, the measurement value data, the additional measurement value data, the data editing function, the joint transmission and the rules.

The method using the request message with specification of the editing function can also be used in particular for image editing functions or measurement value editing functions which have to be performed with comparatively substantial computing effort, and/or for image data or measurement value data for which it is established that they will in any case be required again, e.g. immediately, within a specific period or e.g. on the next day.

The picture archiving unit may contain an image data store with a storage capacity greater than 1 terabyte or even greater than 100 terabytes, in particular a short-term storage unit for storing the image data for less than e.g. 6 months. The specified data volumes may also contain the measurement value data.

A user retrieving the image data or the measurement value data could thus be interested only in the edited image data or the edited measurement value data. In this case, the unedited data do not have to be transmitted via a data transmission network.

The data editing function may be defined in a dataset which is stored in the picture archiving unit, in particular in a dataset which meets the DICOM standard or the HL7 standard. The data editing function can thus be recorded in a simple manner in the PACS.

In one design, the picture archiving unit may contain only the second data processing system or a plurality of data processing systems on which at least one of the aforementioned method steps is in each case carried out. Groups or clusters of data processing systems containing more than 10, more than 100 or even more than 1000 data processing systems can thus be used, wherein, however, the first data processing system does not belong to the cluster.

The arrangement of the image editing functions in the cluster may, particularly in the case of very large clusters, result in a considerable reduction in the data traffic outside the cluster. In one design, at least two or all data processing systems of the picture archiving unit may be interconnected via a data transmission connection with a data transmission rate which is at least three times or at least ten times higher than the data transmission rate between the first data processing system and the second data processing system.

Clusters of computers with particularly fast data transmission connections or bus systems can thus be interconnected, e.g. more than 10, more than 100, or more than 1000 data processing systems. Fast access and therefore also a fast editing of the image data in the PACS or a different archiving system are thus possible.

In one design, the picture archiving unit may contain a first storage unit and a second storage unit, wherein image data are stored in the second storage unit for a period of time which is longer than a period of time for the storage of the image data in the first storage unit, e.g. more than four times more than ten times longer.

The access time of the second storage unit may be less than the access time of the first storage unit, e.g. by more than 10 percent or more than 50 percent in relation to the access time of the first storage unit.

The image data, the measurement value data or the additional data may be stored, for example, for a maximum of six months in the first storage unit. The image data, the measurement value data or the additional data may be stored, for example, for longer than two years in the second storage unit.

RAID (Redundant Array of Independent Disks) systems can be used in both storage units, in which the data are stored or mirrored multiple times. However, the outlay for the mirroring or data backup may differ in size in the two storage units.

In particular, the outlay for the data backup in the first storage unit may be higher.

Magnetic storage media, electronic storage media, such as e.g. EEPROMs (Electrically Erasable Programmable Read Only Memory) or Flash EEPROMs, solid state disks (SSD) or other storage types can be used. The storage type of the first storage unit may differ from the storage type of the second storage unit.

The picture archiving unit may also communicate with imaging devices as provided, for example, in the DICOM standard. The imaging devices may be the aforementioned devices, e.g. computer tomograph (CT), MRT, etc. In this way, relevant additional image data can be retrieved automatically, directly from the devices.

The image data may contain or may be medical data and/or the measurement value data may contain or may be medical measurement value data. The proposed solutions can be employed particularly effectively, specifically in the field of medicine, since very large data volumes have to be edited.

The additional image data or the additional measurement value data may be structured according to the DICOM standard or a standard based thereon. The DICOM standard is based on an object-oriented information model and enables data exchange via point-to-point connections and/or via networks and/or via the exchange of transportable media. The DICOM standard goes back to ARC (American College of Radiology) NEMA (National Electrical Manufacturers Association) 300-1985 or version 1.0.

The Information Object Definitions (IOD) of DICOM 3.0 are specified in the following two tables:

Composite IODs

Computed Radiography Image
Computed Tomography Image
Magnetic Resonance Image
Nuclear Medicine Image
Ultrasound Image
Ultrasound Multi-Frame Image
Secondary Capture Image
Standalone Overlay
Standalone Curve
Basic Study Description
Standalone Modality Lookup Table (LUT)
Standalone Value of Interest (VOI) LUT

Normalized IODs

Patient Information
Visit Information
Study Information
Study Component Information
Results Information
Interpretation Information
Basic Film Session
Basic Film Box
Basic Annotation Presentation
Basic Print Job Information
Basic Printer Information
VOI LUT
Image Overlay Box

A computed tomography according to DICOM is, for example, specified in the following table (Computed Tomography Image IOD Module Table):

| Information Entity | Module | Usage |
|---|---|---|
| Patient | Patient | M (mandatory) |
| Study | General Study | M |
| | Patient Study | U (user option) |
| Series | General Series | M |
| Frame of Reference | Frame of Reference | M |
| Equipment | General Equipment | M |
| Image | General Image | M |
| | Image Plane | M |
| | Image Pixel | M |
| | Contrast/Bolus | C (conditional) |
| | CT Image | M |
| | Overlay Plane | U |
| | VOI LUT | U |
| | SOP (Service Object Pair) | M |
| | COMMON | |

A Patient Module contains, for example, the following data according to DICOM:

| Attribute Name | Tag | Type | Attribute Description |
|---|---|---|---|
| Patient's Name | (0010, 0010) | 2 | Name of the patient |
| Patient ID | (0010, 0020) | 2 | Patient identification number |
| Patient's Birth Date | (0010, 0030) | 2 | Date of birth of the patient |
| Patient's sex | (0010, 0040) | 2 | Gender of the patient |
| Referenced Patient | (0008, 1120) | 3 | Reference to another sequence |
| Sequence | | | |
| Referenced SOP | (0008, 1150) | 1C | Reference to SOP Class UID |
| Class UID | | | (Unique Identifier) |
| Referenced SOP | (0008, 1155) | 1C | Reference to SOP Instance |
| Instance UID | | | UID |
| Patient's Birth Time | (0010, 1132) | 3 | Time of birth of the patient |
| Other Patient ID | (0010, 1000) | 3 | Another patient identification |
| | | | number |
| Other Patient Name | (0010, 1001) | 3 | Another name of the patient |
| Ethnic Group | (0010, 2160) | 3 | Religious affiliation of the |
| | | | patient |
| Patient Comments | (0010, 4000) | 3 | Other information on the |
| | | | patient |

Similar specifications apply to measurement value data, e.g. ECG (electrocardiogram), EEG (electro-encephalogram, US (ultrasound), blood flow velocity values, etc.

For the message exchange, DICOM defines a message transmission service, DICOM Message Service Element, which is based on TCP/IP (Transfer Control Protocol/Internet Protocol), ISO OS (International Standardization Organization Open System) or point-to-point interfaces. The combination of an information object and a data service of this type is referred to as the Service Object Pair (SOP). The SOP class represents the basic functional unit which is defined in DICOM. Through the definition of an SOP class, it is possible to define a specific subset of the DICOM functionality.

However, the additional image data or the additional measurement value data may also be structured, for example, according to the EXIF (Exchange Image File) standard or a standard based thereon. Alternatively, the additional image data may be structured according to the HL7 (Health Level 7) standard or a standard based thereon, which is similarly widely used in some fields of medicine.

Widely used standards, which are suitable, in particular, for medical image data or measurement value data also, are therefore employed.

The additional image data or the additional measurement value data may contain at least one, at least two or at least three of the following data: —a datum to indicate the identity of a patient,
a datum which indicates the day and/or the month and/or the year of the recording of the image data or the measurement value data,
a datum which indicates a clinical situation in connection with the image data or the measurement value data, e.g. image of the liver, or liver for short,
a datum which indicates the nature and/or the type and/or the manufacturer of the recording device that has been used to record the image data or the measurement value data,
a datum which indicates the name and/or the address and/or an identifier of the institution recording the image data or the measurement value data,
a datum which indicates a focal length and/or an aperture setting in the recording of the image data,
a datum which indicates GPS (Global Positioning System) data or other data for identifying the recording location of the image data or measurement value data,
a datum which indicates the recording angle in the recording of the image data.

These data are particularly suitable for use as decision criteria to determine which image editing function or other data editing function is to be carried out. However, further data are similarly suitable, e.g. a time of the recording of the image data or the measurement value data, etc.

In the method for storing image data, the or at least a part of the additional image data transmitted jointly with the image data can be transmitted separately from the image data in a message to a control unit which has access to the stored rules. In particular, a copy of the additional image data may be contained in the message. Alternatively, the or a part of the additional measurement value data transmitted jointly with the measurement value data can be transmitted separately from the measurement value data in a message to a control unit which has access to the stored rules. The image data or the measurement value data themselves do not therefore have to be transmitted unnecessarily in the picture archiving system.

In the method for requesting or reading image data, the determined additional image data or additional measurement value data or the additional image data or additional measurement value data contained in the request message can be transmitted in a message to a or to the control unit which has access to the stored rules. In particular, a copy of the additional image data or additional measurement value data can be contained in the message. The image data or measurement value data themselves do not therefore have to be transmitted unnecessarily in the picture archiving system.

The control unit can evaluate the additional image data contained in the message using the stored rule or rules. The control unit can generate a further message for an image editing unit or a different data editing unit (measurement value data, additional image data, additional measurement value data), wherein the further message contains, in particular, an identifier to specify the data editing function, in particular an image editing function, and/or the additional data, e.g. additional image data. This separation of the evaluation of the rules and the image editing function enables a simple programming and/or maintenance of the picture archiving system.

The control unit can generate the further message with a time delay in relation to the first message, which is introduced intentionally, e.g. with a delay greater than 5 minutes or greater than 30 minutes.

However, the delay may be less than 24 hours or less than one week. Thus, particularly during the night or on Saturdays or Sundays, it can be calculated where more processing capacity can be available than during the day or on the working days of a week. For example, batch processes can be used with which a multiplicity of identical data editing functions, in particular image editing functions or measurement value editing functions, are carried out for a multiplicity of data. The performance in the editing of the data can be increased as a result. A data editing function therefore needs to be initialized, for example, once only or a few times only, and can then be used to edit the data of a plurality of images or measurement value series, in particular to edit more than 10, more than 100 or more than 1000 images or measurement value series.

An asynchronous editing is therefore carried out. The receiving or storing of the received data is therefore temporally decoupled from the data editing itself. Similarly, the receiving of the request message can be temporally decoupled from the data editing itself.

The image editing or the editing of other data (measurement value data, additional data) can also be based on incremental methods to which only newly added image data are subjected.

At least one message containing an identifier for a data editing function, in particular an image editing function or a measurement value data editing function, and command code for a data editing function, in particular an image editing function or a measurement value data editing function, can be transmitted from the first data processing system to the second data processing system. The identifier and the command code can be stored in a or the image editing unit.

Through this measure, data editing functions can be inserted following the completion of the initial installation of the picture archiving program or system. Alternatively or additionally, such functions can also be permanently predefined in the picture archiving program system.

The data editing functions can thus be adapted in a simple manner to the needs of a user or a plurality of users of the PACS or a different picture archiving system. Updates of individual data editing functions can be carried out at a central location, similarly in a simple manner.

The command code is, for example, Java code, JavaScript code or C code, in particular C++ code or Visual C code. The command code may be object-oriented and/or sequential code which, for example, can be executed by a processor following a compilation and/or a link process, in particular a dynamic link process.

The identifier for the image editing function can also be used in at least one stored rule. The identifier for the image editing function can be used in one of the aforementioned messages.

At least one message in which an identifier for at least one data editing function, in particular an image editing function or measurement value editing function, and at least one rule are specified, said rule defining the condition under which the data editing function is to be performed depending on additional image data or additional measurement value data, or serving to establish whether a function affected by the rule is applicable to a dataset, can be transmitted from the first data processing system to the second data processing system. The rule can be stored in such a way that a control unit has access to it, wherein the rule is stored, in particular, in the control unit.

Through this measure, the rules or rule can be inserted following the completion of the initial installation of the picture archiving program or system. Alternatively or additionally, such rules can also be permanently predefined in the picture archiving program or system.

The rules can thus be adapted in a simple manner to the needs of a user or a plurality of users of the PACS or a different picture archiving system. Updates of individual rules can be carried out at a central location, similarly in a simple manner.

A data processing system or a data processing system assembly, in particular for carrying out one of the methods explained above, may contain:
a data editing unit integrated into a picture archiving unit, and
a control unit which has access to at least one rule in which the condition is specified under which at least one data editing function is to be carried out depending on additional image data or additional measurement value data, or which specifies a data editing function depending on an identifier which has been defined for a dataset or for a data object.

The aforementioned first DP system and/or the similarly aforementioned second DP system, in particular, may belong to the DP system assembly. However, the DP system assembly may contain only the second DP system and further DP systems, wherein, however, the first DP system is not included in the data processing system assembly.

The technical effects indicated above for the method and its developments apply, in particular, to the DP system or to the DP system assembly.

“Integrated” means, in particular, a linking of programs and/or program parts with a larger program package, in particular dynamically also, i.e. in the program runtime. In other words, a standardized environment, for example, is specified for the processing in the memory of, for example, medical image data.

The processing of medical image data by computer systems is becoming increasingly important for various reasons. According to one study, the introduction of IT (Information Technology) is, for example in the healthcare sector in some countries, a strong trend, see e.g. “Electronic Health Records: A Global Perspective”, Healthcare Information and Management Systems Society (HIMSS), pp. 6 to 7.

The processing of, for example, medical image data requires a very large amount of memory resources due to the required precision and wealth of detail of the data. If an existing image is to be edited or processed, it must first be requested from the storage system and transmitted to the processing station or to the processing server (service provision computer) in a client-server-based image processing system, wherein the client can also be referred to as a service usage computer. Following the editing steps, the updated image is transmitted back into the storage system once more.

The transmission back and forth is disadvantageous due to:
the consumption of bandwidth for the transmission of the image data between the storage system and the processing station,
the delay until the updated image has been transmitted back—it is thus available to third parties at a later stage only, and
the requirement to be able to carry out e.g. medical image data analysis in an increasingly automated manner, particularly in terms of Computer Based Image Retrieval (CBIR) systems for the medical sector and Computer Aided Diagnosis (CAD or CADx). The following problems or partial problems may arise: 1.1 Load on the medical workstation and its infrastructure in terms of processing capacity:
Calculations require powerful hardware and software. The costs per workstation and software program (procurement or leasing and maintenance) may be substantial, e.g. in larger hospitals or practices,
Increasing use of mobile terminal devices requires the avoidance of processing-intensive procedures on the terminal device in order e.g. to utilize the battery capacity efficiently.
Client-server architectures for e.g. medical image editing can reduce the cost problem by enabling the use of low-cost hardware and software on the client.

1.2 Load on the medical workstation or on the mobile terminal device and consequent poor UI (User Interface) experience or poor operability:
If the client performs fewer calculations and is largely relieved of image data transmission tasks, i.e. work steps are carried out on a server, the client can interact more smoothly with the user and, where relevant, is not blocked, which would result in a better UI (User Interface experience.

1.3 No central optimization of image processing or image editing algorithms:
For example in the medical sector, image processing methods are being continuously improved and optimized, since, with an increasing number of edited cases, new findings can be integrated into the algorithms. When these methods are rolled out on the medical workstations, a substantial editing effort is required to update the methods.

1.4 High transmission costs and poor transmission quality in networks:
Low-cost data stores for large volumes of e.g. medical image data are supplied to an increasing extent by cloud providers (server farm). In order to reduce the resulting transmission costs and assure transmission quality, optimizations are required in terms of placement of the data, available network bandwidths and latency. The aim of the measures is to attain approximately the previous standards once more in the LAN (Local Area Network.
With regard to the transmission of image data, the situation concerning transmission is more likely to deteriorate, since the average data volume per image or 3D (three-dimensional) scan will increase.

The prior art consists in that the editing or processing is undertaken on the processing station. This results in the disadvantages described above.

Database-oriented storage systems allow the feed-in of procedural code for the execution of stored procedures on the basis of ordered events. However, these stored procedures are not adequate tools for processing image data, in particular medical image data. They are provided instead for the editing of tabular data. The method is essentially known for textual data in the form of stored procedures:

In this way the contents of database tables can be manipulated directly in the storage system.

Stored procedures are unsuitable for complex processes and algorithms due to the deficient facilities for structuring and deficient constructs, so that their own data structures, instructions, and arithmetical operations are lacking.

Distributed Map Reduce (Hadoop MR) solutions are optimized to perform parallel calculations on large data volumes in computer clusters directly in the nodes (computer nodes) in which the data are stored, but offer no fundamental functionality for editing image data, in particular medical image data, nor the corresponding interfaces. Map Reduce solutions are typically appropriate only if the operations are applicable to a large part of the stored data and are readily parallelizable.

Specifically in the case of medical image data or medical measurement value data, for example, the server-side processing is more useful due to the aforementioned problems with the data volume and the transmission bandwidths. A medical image processing step could thus be made available centrally for medical workstations that are placed at different locations. This would be possible with a conventional application server which can be installed in addition to the PACS system. However, the approach would have the disadvantage that a separate application server is poorly integrated and requires separate maintenance.

A runtime environment for the execution of processing steps for image data, in particular for medical image data, can therefore be provided in the image data store, i.e. in the specific case of medical image data or other image data, in a PACS. Measurement value data and additional data can similarly be integrated.

This form of application architecture resolves the previous paradigm of a 3-layer architecture which is described as follows:
In the normal case, the image operations can be carried out on a medical workstation or a medical terminal. In a further case, the medical terminals are designed as front ends which are operated on the server side by a presentation layer.
The image processing operation is then placed in the logical layer of the application server.
Finally, the storage of the data is carried out by a persistence layer (data warehousing layer), i.e. as implemented in standard systems.

This paradigm is resolved by a novel processing architecture that is made available by a novel infrastructure:

Standardized image processing steps are placed in the persistence layer or storage layer in the form of a module and are carried out following the feeding of the module into the memory.
Simple processing steps here may entail:
   operations to improve image quality, and/or
   automated addition of annotations, and/or
   automated marking of points of interest,
Complex processing steps may be operations that are significantly improved in the case of a server-side execution. These may, for example, be operations that are carried out in connection with existing image data in the memory, since the algorithms benefit from a global perspective and/or are based on learning methods.
A single processing step may be provided in the form of a standardized package that is transmitted as a module into the PACS server and is available there for execution.
As a further condition, processing steps can be carried out asynchronously. The processing steps are in each case initiated by corresponding marking of the metadata or additional image data in the picture archive or in the user-definable metadata or additional image data, insofar as supported by the file format.

The system may consist of a plurality of components:
A: one or more medical image processing applications or application programs.
B: a PACS server which technically consists of one or more computers, with the following subcomponents:
B1: an image store of the PACS server,
B2: an execution environment for the standardized modules, see PACS EE in the figures,
B3: a decider which determines for newly added image elements whether a module is to be executed or not, see PACS CE in the figures,

Concerning B2, i.e. the runtime environment which provides medical evaluations or image processing steps for execution: The runtime environment standardizes or represents an API (Application Programming Interface) for the image editing modules, i.e. an interface which implements the file access to the image data contained in the PACS. The API enables operations that are normally carried out locally on the image processing workstations. The aim is to place image editing programs which run on the user workstation in the “PACS EE”. As a result, transmission times can be saved, i.e. the image operation is closer to the storage or memory, and the resource consumption can be reduced, i.e. fewer resources are consumed if fewer transmissions take place.

Concerning B3, i.e. concerning the interface which allows the storage of definitions or rules: The definitions define the condition under which an image editing module is executed. Conditions may relate, for example, to a certain age of the file or to a recording angle or to a specific imaging device with which the image was created. The conditions may relate to the fields that are defined, for example, by the DICOM format.

The dynamics may be represented in the sequence diagram shown in FIGS. 1 and 2, which are explained in detail below.

The transmission of data in relation to the execution code for processing medical image data is reversed in the sense that:
image processing steps are migrated from the medical workstations or proprietary application servers onto the storage infrastructure,
image processing operations can be reversed asynchronously onto activities of the client but do not necessarily have to be carried out synchronously,
image processing operations are combined in a component which is executable on the PACS server,
image processing operations in the PACS server can be designed as modular and, for example, linked dynamically in such a way that they can be exchanged or updated with more recent implementations,
image processing operations in the PACS server can be reachable or retrievable from medical workstations, so that the medical workstations can undertake parameterizations or adaptations can be carried out in the sense of an administrator functionality, i.e. the specification of the rules and the transmission of image editing modules. The transmission of ancillary modules that are required by the image editing modules would also be included. A further point would be the definition of access rights or execution rights.

The image data are thus no longer manipulated on the workstations, but rather on the server side in the memory. Due to the storing of the image processing modules in the PACS system, the entire system can be scaled centrally and relates less to the capacity of an image processing workstation or a mobile device.

In this way, further transmissions of the medical image data from the PACS server can be avoided. On the one hand, this relieves the I(Input)/O(Output) capacity of the PACS server (service provision computer) and, on the other hand, relieves the medical workstations by addressing or solving the aforementioned problems 1.1, 1.2 and 1.3. A further advantage can be achieved if, for example in a DICOM image series, a quantity or a set of image data is edited or transformed dependently on one another. An increased processing effort would be required here due to the concatenation of image data in a conditional manner.

In one example embodiment, medical image data, for example, can be loaded into a storage system in the DICOM format. One processing step here may entail the extraction and conversion of the 2D (two-dimensional) images contained in a DICOM file. For example, all images contained in a DICOM file can be extracted as JPEG (Joint Photographic Experts Group) image data. For example, EXIF data can be placed in the header of the JPEG format. Examples of EXIF data are the date, time of the recording, exposure parameters, preview images, copyright notices, etc.

It is assumed that the DICOM files have already been loaded into the storage system. The further steps then normally entail the reloading of the files from the storage system, the performance of the extraction and the transmission back into the storage system.

It is now proposed to design the extraction of DICOM data as a module and to load this module into the storage system. The module, i.e. the extraction of the image files, is executed there on the server side without transmission procedures being required.

Methods for CBIR (Content Based Image Retrieval), inter alia, can be considered as a further application. CBIR entails the enablement of the search for a specific image content through recognition of the image contents. In the configuration described above, CBIR methods can be applied to newly arriving image data so that the data are generated or implemented for the search for image contents. Algorithms, for example, are used for the extraction of features in CBIR. CBIR is improved here by two circumstances:

a) For the cluster formation of recognized features and the specification of the recognition rate, the feature recognition benefits from a global perspective of the images. In this respect, the use of CBIR on medical workstations would be disadvantageous.

b) In order to load new features for the recognition, a server-side approach is similarly advantageous, since the software would otherwise have to be updated on, for example, medical image processing workstations.

In CBIR, the textual data are stored as metadata of the image. In DICOM, this means the use of user-definable tags as DICOM data elements.

The characteristics, features and advantages of this invention described above, and the manner in which these are achieved will become clearer and more readily understandable in connection with the following description of the example embodiments. Insofar as the term “can” is used in this application, this means both the technical possibility and the actual technical implementation. Insofar as the term “approximately” is used in this application, this means that the exact value is also disclosed.

The figures are not drawn to scale and, in particular, the aspect ratios can be selected differently.

Example embodiments of the invention are explained below with reference to the attached drawings, in which:

FIG. 1 shows method steps in the storing of image data,

FIG. 2 shows method steps in the reading of image data,

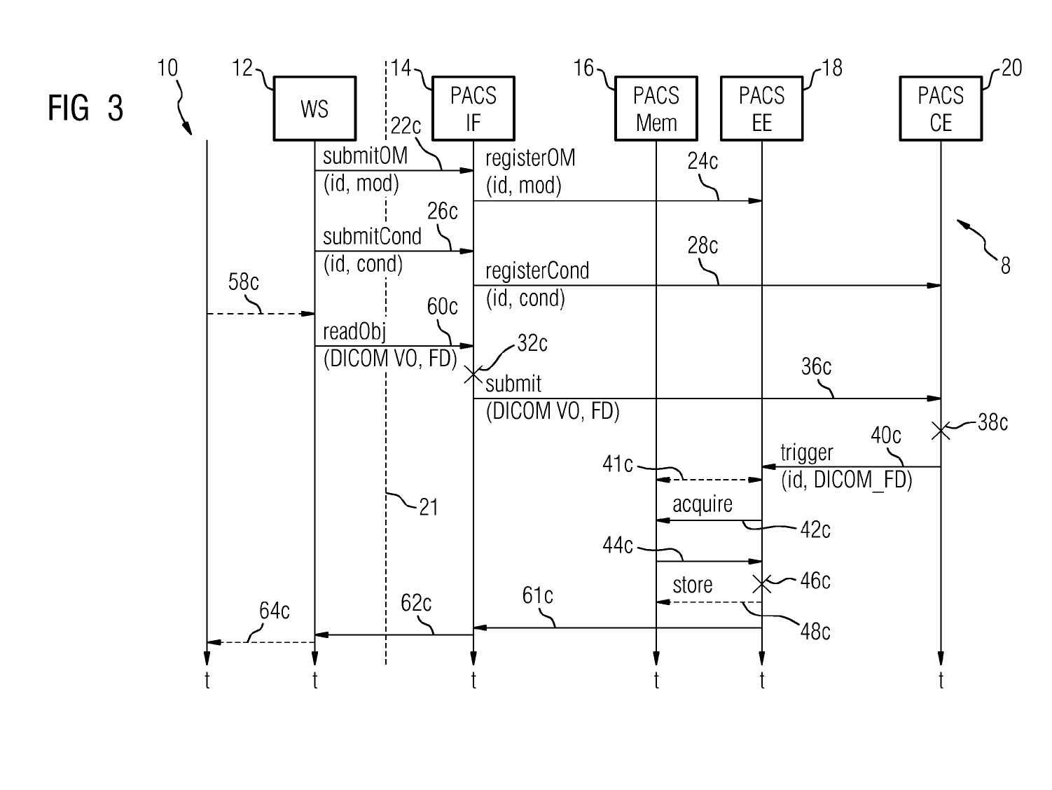

FIG. 3 shows method steps in the reading of image data according to a second variant,

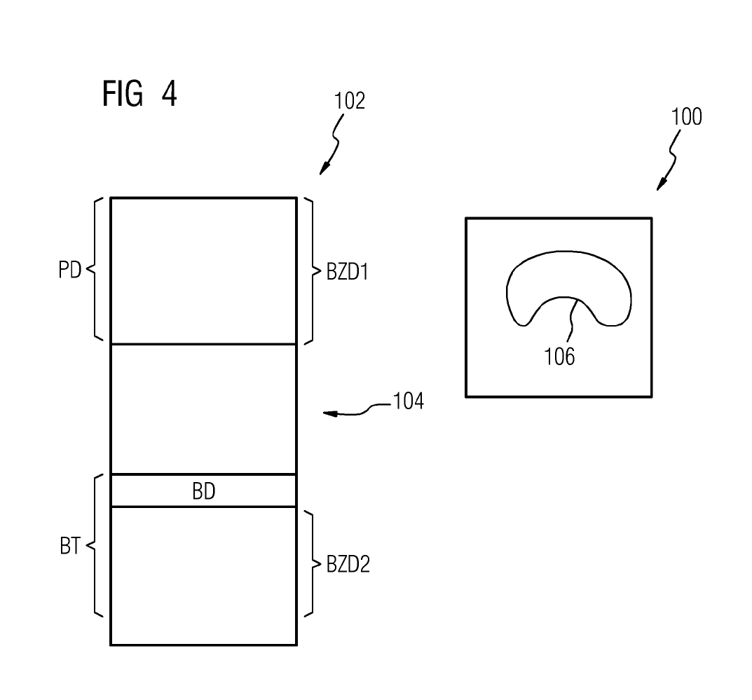

FIG. 4 shows the structure of image data and additional image data,

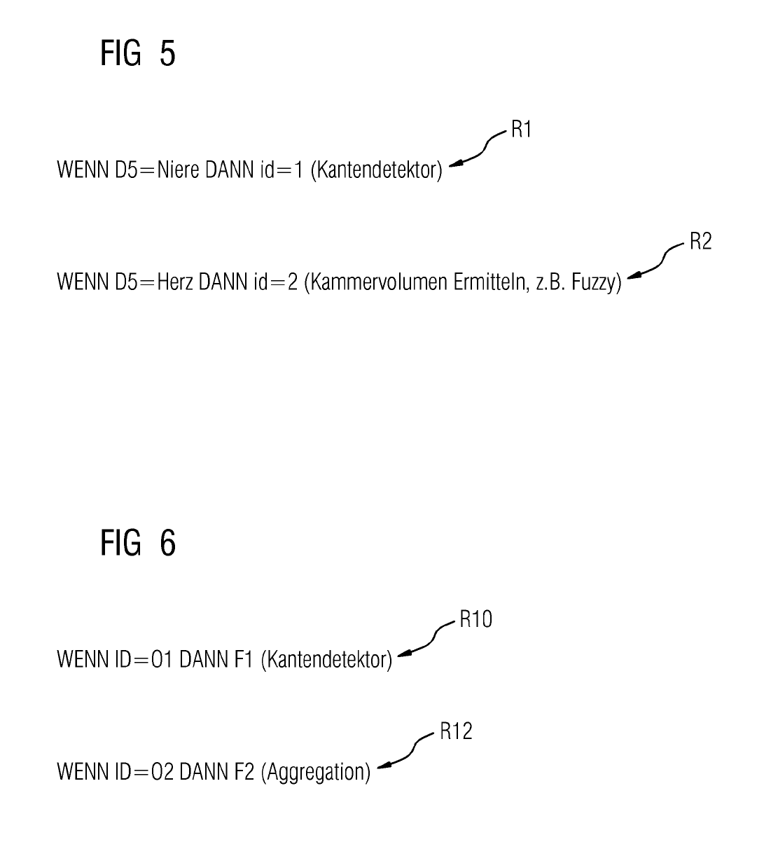

FIG. 5 shows two rules for the automatic image editing, and

FIG. 6 shows two rules for the automatic image editing according to the second variant.

FIG. 1 shows method steps in the storing of image data. In FIGS. 1 and 2, a vertical timeline of the time t is shown for each relevant unit, wherein events occurring approximately simultaneously lie at the same horizontal height on the timelines.

The method steps are carried out using a picture archiving system, e.g. using a PACS 8, which is shown in FIG. 1 to the right of a dividing line 21.

To the left of the dividing line 21, a data processing system 12 is shown, e.g. a workstation, a personal computer or a terminal, such as e.g. a tablet PC or smartphone.

Application software 10, for example, is installed on the data processing system 12, for example the interface of an image editing program.

The PACS 8 may contain a data processing system (DP system) or a plurality of DP systems on which a plurality of units are disposed, see e.g.:
interface 14, e.g. PACS IF (Interface),
image data store 16, which is also referred to as PACS Mem (Memory),
image editing unit 18, which is also referred to as PACS EE (Execution Environment),
control unit 20, which is also referred to as PACS CE (Condition Evaluator).

Before the PACS 8 is used, it is configured, for example, using the DP system 12. To do this, an optional message 22 is transmitted from the DP system 12 to the interface 14, for example via a wired, a fiber-connected or a wireless network (radio). The message 22 is, for example, a message with the name submitOperationModule and contains, for example:
an identifier id which designates an image editing function, and
“module” data which define an image editing module or the image editing function, for example a Java class or C class, e.g. C++ or Objective C. More precisely, the command code or the major part of the command code of the image editing function designated by the identifier id is defined or contained in the “module” data.

On the basis of the message 22, the interface 14 generates an optional message 24 which is transmitted from the interface 14 to the image editing unit 18. The message 24 has, for example, the name registerOperationModule and contains:
the identifier id from the message 22, and
the “module” command code data from the message 22.

The interface 14 and the image editing unit 18 may be located on the same DP system or on different DP systems.

The “module” data are stored in the image editing unit 18 or are integrated into the command code of the image editing unit 18, which takes place immediately or on demand, in particular using a compiler and/or using dynamic linking, i.e. a linking in runtime.

Alternatively, the image editing function defined by the “module” data can also be permanently integrated into the PACS 8, i.e. can already be integrated during the installation of the latter into the image editing unit 18. Further image editing functions can be installed by further submitOperationModule messages which originate, for example, from the DP system 12 or from other DP systems.

Before the PACS 8 is used, it is further configured, for example using the DP system 12. An optional message 26 has the name submitConditions and contains:
an identifier id for an image editing function of the image editing unit 18, and
at least one of the “conditions” specifying the conditions under which the image editing function designated by the identifier id is to be performed depending on additional image data.

The additional image data are explained in further detail below with reference to FIG. 4. Examples of conditions and rules are explained in further detail below with reference to FIG. 5.

On the basis of the message 26, the interface 14 generates an optional message 28 which is transmitted from the interface 14 to the control unit 20. The message 28 bears, for example, the name registerConditions or contains an identifier specifying this name. The message 28 furthermore contains:
the identifier id from the message 26, and
the “condition(s)” from the message 26.

The interface 14 and the control unit 20 may be located on the same DP system or on different DP systems.

The control unit 20 records the transmitted rule in an internal storage unit or in an external storage unit to which the control unit 20 has access. When the image data are accessed, the rules recorded in the control unit 20 are checked and, where relevant, result in corresponding image editing steps, which is explained in further detail below with reference to FIG. 1 and FIG. 2.

Alternatively, the condition or the rule defined by the “conditions” data can also be permanently integrated into the PACS 8, or can be integrated during the installation of the latter into the control unit 20. Further conditions and rules can be installed through further submitConditions messages which originate, for example, from the DP system 12 or from other DP systems.

Confirmation messages, e.g. for the message 22 or 26, can be transmitted according to the DICOM standard.

It is assumed that an operating person initiates the transmission of image data from the data processing system 12 to the PACS 8 through a user input 6. A message 30 is then transmitted from the DP system 12 to the interface 14, for example via a wired, a fiber-connected or a wireless network (radio).

The message 30 bears the name sendObject or a corresponding identifier. Furthermore, the message 30 contains image data and additional image data, for example DICOM data generated according to the DICOM standard which contain both pixel data and additional image data, which is shown in FIG. 1 by the name “image”. Data objects and data fields of the DICOM data were described in the introduction, so that reference is made here to these descriptions.

The DICOM data fields or the field data are extracted in the interface 14 or in the interface unit 14 following the reception of the message 30, wherein the image data are not included, see time 32. The field data are the additional image data or DICOM data elements.

The interface unit 14 then stores the actual image data and the additional image data in the image data store 16, for which purpose, for example, a message 34 is used. The message 34 is designated, for example, as storeImage and contains the image data and the additional image data, referred to here as “image” for short.

Furthermore, the interface unit 14 generates a message 36 before or after the storage of the image data. The message 36 is also designated as submit and contains the DICOM field data, wherein the actual pixel data are not included. The message 36 is associated with an asynchronous access to the data stored with the message 34, which takes place at a later time. The message 36 is transmitted from the interface unit 14 to the control unit 20 and is further edited there, for example depending on a predefined scheduling function, which ensures an effective performance of image editing functions.

The control unit 20 receives the message 36 and evaluates the DICOM field data contained therein at a later time 38 according to the rules R1, R2, etc., stored in the control unit. If a rule applies, a scheduling function can be performed which specifies when the image editing function to be performed is started, for example at a specific time or in a specific time period. It can also be ensured, for example, that a defined minimum number of images that are to be edited with this image editing function have been received. However, the operation can also be carried out without a scheduling function, e.g. according to the FIFO (First In First Out) principle.

It is assumed that the control unit 20 generates a message 40 at a time occurring after the time 38 in order to start an image processing function on the basis of the message 36. The message 40 is named, for example, “trigger” and contains:
an identifier id which is specified by a fulfilled rule and defines the image editing function that is to be performed, and
the DICOM field data.

The message 40 is transmitted from the control unit 20 to the image editing unit 18 in order to trigger the associated image editing.

The image editing unit 18 receives the message 40 and determines the image editing function that is to be performed, designated by the identifier id. Furthermore, the image editing unit 18 submits a request to read the image data designated by the DICOM field data from the image data store 16, see message acquireImage(data), wherein “data” specifies the image data to be read.

The image data store 16 is located, for example, on the same data processing system as the image editing unit 18. Alternatively, however, the image data store 16 is located on a different DP system. Both DP systems can be connected by a particularly fast data transmission network or bus system, e.g. a backplane.

At a time 44, the image data are transmitted from the image data store 16 to the image editing unit 18 and are edited there according to the image editing function designated by the identifier id in the message 40, see the cross or time 46.

The edited image data are then stored in the image store 16 in addition to or instead of the image data read in step 44, for example using a storeImage(image) message 48 from the image editing unit 18. The associated additional image data, i.e. the DICOM field data, are similarly stored for the edited data. The data transmitted with the message 40 or the data read in step 44 can be used for this purpose.

Further sendObject messages from the DP system 12 or from other DP systems are edited by the PACS 8 in the same way. Read requests can also be edited by the PACS 8, which is explained in further detail below with reference to FIGS. 2 and 3.

The stored original image data and/or the stored edited image data can be retrieved on demand from the DP system 12 or from the application program 10 or from other DP systems or application programs, wherein, for example, no further editing is carried out. Alternatively, however, a further editing can be carried out when the image data are retrieved, which is explained in further detail below with reference to FIGS. 2 and 3.

In one example embodiment, the image editing carried out at the time 46 consists, for example, in the extraction of JPEG (Joint Photographic Experts Group) image data. The aim of the extraction is, for example, to check whether a thumbnail view (preview) can be found as an EXIF entry in the JPEG header.

The image editing can be started asynchronously by a corresponding identification of the metadata (additional image data) in the picture archive or image data store. For example: If no thumbnail view (preview) is available, this is generated from the original image as an image processing step. This editing step is then stored in a rule which is executed, where relevant, immediately following the extraction or later.

Alternatively, the image editing can be started asynchronously in the user-definable metadata or additional image data, insofar as supported by the file format. These data may be further data, for example those created through CBIR.

In a further example embodiment, an automatic image recognition method is carried out at the time 46 in the context of the CBIR. The recognized structures are classified. The acquisition result is automatically recorded in the additional image data, for example in text form, which is also human-readable. The feature recognition can be improved manually or automatically in stages, since the image editing function is performed centrally for a very rapidly expanding database. In particular, the acquisition rate can be increased quickly, since a multiplicity of images are available at a central location. In the case of the image processing on the user workstations, these functions would have to be updated individually, thereby incurring an administrative/organizational overhead. The overhead for certification or for acceptance testing during commissioning is also much less if the software is updated on one (server) computer only, rather than on X image editing workstations.

FIG. 2 shows method steps in the reading of image data. The same PACS 8 as explained above with reference to the figure can be used. Alternatively, a different PACS can be used which, however, contains the same units as the PACS 8. The statements made above thus apply to the following units in connection with FIG. 2 also:
application program 10,
data processing system 12,
interface unit 14,
image data store 16,
image editing unit 18, and
control unit 20.

The statements made with reference to FIG. 1 regarding the following messages or times continue to apply:
an optional message 22b submitOperationModule(id, module), containing an identifier id and “module” code data, corresponds to the optional message 22,
an optional message 24b registerOperationModule(id, module) corresponds to the optional message 24,
an optional message 26b submitConditions(id, conditions) corresponds to the optional message 26,
an optional message 28b registerConditions(id, conditions) corresponds to the optional message 28,
the time 32 corresponds to a time 32b, i.e. extraction of the DICOM field data,
a message 36b submit(DICOM field data) corresponds to the message 36,
a time 38b, evaluate(DICOM field data), corresponds to the time 38,
a message 40b trigger(id, DICOM field data) corresponds to the message 40,
a request 42b corresponds to the request acquireImage(data) 42,
a transmission 44b of the image data corresponds to the transmission 44 of the image data,
an editing 46b corresponds to the editing 46 of the image data, and
an optional message 48b, storeImage(image) corresponds to the message 48.

However, instead of the user input 6, a user input 58 by means of which the image data are requested, for example through input of a patient identifier, is performed in the method shown in FIG. 2.

Instead of the message 30, a message 60, which is also designated as readObject and contains the DICOM field data, is generated by the DP system 12. Alternatively, the message 60 contains only an identifier which allows the determination of associated DICOM data. The message 60 is transmitted from the DP system 12 to the interface unit 14. The message 60 contains no pixel data.

Following the receipt of the message 60 in the interface unit 14, step 32b is carried out, wherein the DICOM field data of the message 60 are read. Alternatively, a memory access can be carried out in order to read the DICOM data depending on an identifier, for example from the image data store 16.

Since there are no pixel data in the message 60, a message corresponding to the message 34 storeImage(image) is absent from the sequence shown in FIG. 2. However, the DICOM field data are forwarded in the message 36b from the interface unit 14 to the control unit 20, whereupon step 38b is carried out and the message 40b is transmitted. The method is then continued as explained above with reference to FIG. 1, see reference numbers 42b, 44b, 46b and 48b, wherein the storage of the edited image data is optional.

The edited image data can also be transmitted to the DP system 12 only, without a storage taking place in the image storage unit or in the image data store 16, see transmission 61 from the image editing unit 18 to the interface unit 14 and transmission 62 from the interface unit 14 to the DP system 12.

The DP system 12 outputs the edited image data, for example on a screen, by means of the application program or a different program, see screen output 64.

Further messages 68 readObject from the DP system 12 or from other DP systems can be edited by the PACS 8. Write requests can also be edited by the PACS 8, as explained, for example, in detail above with reference to FIG. 1. However, image data write processes can also be carried out without editing.

The stored original image data and/or the stored edited image data can also be retrieved on demand from the DP system 12 or from the application program 10 or from other DP systems or application programs, wherein, for example, no further editing is carried out.

This design offers the advantage that an image editing function can use the image data present at this time in the unit 10 for an aggregation. For example, the message 60c can be coded in such a way that an overlay with the addition of currently available images in work step 46b is requested, which is then transmitted back in message 62 as a newly generated image to the unit 12. In this way, images can be generated which do not yet exist as such in the transmission of the message 60c, but are generated dynamically only on request, which can also be referred to as “virtual” objects.

In a further example embodiment, an automatic image recognition method is carried out at the time 46b in the context of the CBIR. The recognized structures are classified. The acquisition result is automatically recorded in the additional image data, for example in text form, which is also human-readable. The feature recognition can be improved manually or automatically in stages, since the image editing function is carried out centrally for a very rapidly expanding database. In particular, the acquisition rate can be increased quickly, since a multiplicity of images are available at a central location. In the case of the image processing on the user workstations 12, these functions would have to be updated individually, thereby incurring an administrative/organizational overhead. The overhead for certification or for acceptance testing during commissioning is also much less if the software is updated on one (server) computer only, rather than on X image editing workstations.

The method explained with reference to FIG. 2 may be preceded by a storage of original image data, i.e. unedited image data. Alternatively, however, an editing, in particular a preprocessing, can take place during the storage, as explained above with reference to FIG. 1.

In a different example embodiment of the method shown in FIG. 2, the data editing function relates, for example, to a coloring of images or image parts or the definition of sequence of images.

FIG. 3 shows a second variant for method steps in the reading of image data. The same PACS as explained above with reference to FIGS. 1 and 2 can be used. Alternatively, a different PACS 8 is used which, however, contains the same units as the PACS 8. The statements made above thus apply to the following units in connection with FIG. 3 also:
application program 10,
data processing system 12,
interface unit 14,
image data store 16,
image editing unit 18, and
control unit 20.

The statements made with reference to FIGS. 1 and 2 regarding the following messages or times continue to apply:
an optional message 22c submitOperationModule(id, module), containing an identifier id and “module” code data, corresponds to the optional message 22,
an optional message 24c registerOperationModule(id, module) corresponds to the optional message 24,
an optional message 26c submitConditions(id, conditions) corresponds to the optional message 26,
an optional message 28c registerConditions(id, conditions) corresponds to the optional message 28,
the time 32 corresponds to a time 32c, i.e. extraction of the DICOM field data,
a message 36c submit(DICOM field data) corresponds to the message 36,
a time 38c, evaluate(DICOM field data), corresponds to the time 38,
a message 40c trigger(id, DICOM field data) corresponds to the message 40,
a request 42c corresponds to the request acquireImage(data) 42,
a transmission 44c of the image data corresponds to the transmission 44 of the image data,
an editing 46c corresponds to the editing 46 of the image data, and
an optional message 48c, storeImage(image) corresponds to the message 48,
a message 61c corresponds to the message 61, and
a message 62c corresponds to the message 62.

However, instead of the user input 6 or 58, a user input 58c is performed in the method shown in FIG. 3, by means of which a data editing function is requested or a plurality of data editing functions are requested, wherein, where relevant, further parameters can also be specified, such as e.g. a patient identifier, a maximum number of response datasets generated by the editing function, etc.

It could thus be instigated that all JPEG images are subjected to a transformation to TIFF.

Instead of the message 60, a message 60c which, in the format of a DICOM object identifier, indirectly specifies a data editing function is generated by the DP system 12. This indirect specification of a function can also be regarded as a specification of a virtual object (VO). The message 60c may additionally contain DICOM field data FD also.

Following the receipt of the message 60c in the interface unit 14, step 32c is carried out, wherein the DICOM VO data of the message 60c are read, along with any field data FD that are present.

Since there are no pixel data in the message 60c, a message corresponding to the message 34 storeImage(image) is again absent from the sequence shown in FIG. 3. However, the DICOM VO data and any DICOM field data FD that are present are forwarded in the message 36c from the interface unit 14 to the control unit 20, whereupon step 38c is carried out with evaluation of rules which allocate an editing function to the identifier (virtual object) in the message 36c.

The identifier id in the message 40c now specifies the editing function determined using the identifier and the associated rule, e.g. F1 or F2, see also FIG. 6.

When the data editing function is performed, data objects are determined by the image editing unit 18, wherein, where relevant, the transmitted field data FD are also used to interrogate the storage unit 16, see also the explanations relating to FIG. 6. The data editing function may be a function for editing image data and/or measurement value data and/or additional image data and/or additional measurement value data. The data editing function is defined in the image editing unit 18 or in a different manner, which is explained in further detail below.

The method then continues for all determined datasets and data objects as explained above with reference to FIG. 2, see reference numbers 42c, 44c, 46c and 48c, wherein the storage of the edited image data is optional.

The edited image data may also only be transmitted to the DP system 12 without a storage taking place in the image storage unit or in the image data store 16, see transmission 62c.

The DP system 12 outputs the edited image data or other editing results, for example on a screen using the application program or a different program, see screen output 64c.

Further messages 60c readObject from the DP system 12 or from other DP systems can be edited by the PACS 8. Write requests can also be edited by the PACS 8, as explained, for example, in detail above with reference to FIG. 1. However, image data write processes can also be carried out without editing. A combination with the retrievals 60 explained in FIG. 2 is also possible.

The stored original image data and/or the stored edited image data can also be retrieved on demand from the DP system 12 or from the application program 10 or from other DP systems or application programs, wherein, for example, no further editing is carried out.

This design offers the advantage that an image editing function can use the image data present at this time in the unit 10 for an aggregation. For example, the message 60c can be coded in such a way that an overlay with the addition of currently available images in work step 46c is requested, which is then transmitted back in message 62 as a newly generated image to the unit 12. The objects are selected according to the function stored in the image editing unit 18 or taking account of additional data FD or DICOM field data FD.

In a further example embodiment, an automatic image recognition method is carried out at the time 46c in the context of the CBIR. The recognized structures are classified. The acquisition result is automatically recorded in the additional image data, for example in text form, which is also human-readable. The feature recognition can be improved manually or automatically in stages, since the image editing function is carried out centrally for a very rapidly expanding database. In particular, the acquisition rate can be increased quickly, since a multiplicity of images are available at a central location. In the case of the image processing on the user workstations 12, these functions would have to be updated individually, thereby incurring an administrative/organizational overhead. The overhead for certification or for acceptance testing during commissioning is also much less if the software is updated on one (server) computer 8 only, rather than on X image editing workstations.

The method explained with reference to FIG. 3 may be preceded by a storage of original image data, i.e. unedited image data. Alternatively, however, an editing, in particular a preprocessing, can take place during the storage, as explained above with reference to FIG. 1.

In an alternative to the method shown in FIG. 3, the steps to be carried out by the image editing module are not recorded in the image editing unit 18, but rather as a DICOM object in the storage unit 16. This object is therefore requested or read from the storage unit 16 in a step 41c which occurs between steps 40c and 42c. The trigger message 40b can be adapted accordingly. The same applies to alternatives to the methods according to FIG. 1 and FIG. 2, i.e., there also, the steps to be carried out by the image editing module may not be recorded in the image editing unit 18, but rather as a DICOM object in the storage unit 16.

FIG. 4 shows the structure of image data and additional image data BZD1, BZD2. Image data BD belong to an image 100, for example the image of a kidney 106.

The image data BD are embedded in a data block 102 which, for example, meets the DICOM standard. The data block 102 contains patient data PD which are also designated as additional image data BZD1. Examples of patient data are specified above in the table (Patient Module) mentioned in the introduction, e.g. “Patient Identification Number”.

Further data 104, for example, are stored between the patient data PD and a partial image block BT. The partial image block BT contains image data BD, e.g. pixel data in JPEG format or TIFF (Tagged Image File Format). The additional image data contained in the partial image block BT are also designated as additional image data BZD2. Examples of additional image data BZD2 are specified above in the introduction, e.g. “contrast”, “recording angle”, etc.

FIG. 5 shows two rules R1 and R2 for the automatic image editing.

A rule R1 reads:

IF D5=kidney THEN ID=1 (edge detector).

An edge detection is thus carried out with the specification in a data field D5, according to which the static image of a kidney is involved.

A rule R2 reads:

IF D5=heart THEN ID=2 (determine chamber volume, e.g. with fuzzy methods).

In the case of a recording of the heart, the chamber volume of one or both cardiac atria or cardiac ventricles is determined over a plurality of dynamic images of the heart, wherein, for example, a fuzzy method is employed.

FIG. 6 shows two rules R10 and R12 for the automatic image editing according to FIG. 3.

A rule R10 reads:

IF ID=O1 THEN F1 (edge detector).

A function F1, e.g. an edge detection, is thus defined here for an identifier O1. Without further additional data FD, the function F1 would be applied to all suitable objects in the image data store 16. Additional data FD can be used to demarcate the objects under consideration or to find relevant objects. The additional data may be one or more of the following data: —a time restriction, e.g. images recorded in the last month, and/or—specification of a patient, a study or other criterion.

A rule R12 reads:

IF ID=O2 THEN F2 (aggregation).

It is thus specified here for an identifier (ID) O2 (“virtual” object) that is intended to instigate the performance of the function F2, e.g. an aggregation over a plurality of blood pressure values, wherein, for example, a chart or a graph is produced. Additional data FD can be used to demarcate the object under consideration or to find relevant data objects. If no additional data FD are present, all relevant objects, for example, are edited, or a predefined limiting value is taken into account. The additional data may be one or more of the following data:
threshold value for the blood pressure, e.g. all patients who have at any time presented with a blood pressure above a specific value,
a range for the blood pressure, and/or
a time restriction, e.g. in the last month, and/or
specification of a patient, a study or other criterion.

The rules R1, R2, R10 and/or R12 can also be of more complex design, in particular with logical links in the IF part, e.g. AND, OR, XOR or NEGATION. A plurality of functions can also be specified in the THEN part.

Instead of or in addition to the images, measurement value data can also be edited in the methods according to FIGS. 1 to 6. The editing function may also relate only to these or to additional data also.

The rules may also refer, for example, to the age of an image file and/or to the recording angle in the recording of the image data or to other data which are contained in the additional image data BZD1 and BZD2.

The example embodiments are not drawn to scale and are not limiting. Variations in the context of the activity of the person skilled in the art are possible. Although the invention has been illustrated and described in further detail by means of the preferred example embodiments, the invention is not restricted by the disclosed examples, and other variations can be derived here from by the person skilled in the art without exceeding the scope of protection of the invention. The developments and designs specified in the introduction may be combined with one another. The example embodiments specified in the description of the figures may similarly be combined with one another. Furthermore, the developments and designs specified in the introduction may be combined with the example embodiments specified in the description of the figures.

1. A method for editing data, the method comprising:
storing at least one rule in which at least one data editing function is specified, at least one rule that relates to at least one data editing function, or at least one rule in which at least one data editing function is specified and that relates to at least one data editing function;
transmitting at least one message from a first data processing system to a second data processing system;
depending on the at least one message, using the at least one stored rule, determining at least one data editing function; and
performing the data editing function for at least one dataset specified in the at least one message or for at least one dataset determined when the data editing function is performed.

2. The method of claim 1, wherein the storage comprises the storage of at least one rule that defines at least one data editing function depending on additional data,
wherein the one message transmits image data or measurement value data from the first data processing system to the second data processing system,
wherein additional image data or additional measurement value data are transmitted jointly with the image data or the measurement value data, and
wherein the determining comprises determining at least one data editing function for the transmitted additional data using the at least one stored rule, performing the data editing function for the transmitted data, and storing the edited data.

3. The method of claim 1, wherein the storage comprises the storage of at least one rule that defines at least one data editing function depending on additional data,
wherein the one message is a request message for image data or measurement value data from the first data processing system to the second data processing system, reading additional image data or additional measurement value data that have been stored for the data requested in the request message or accessing additional image data or additional measurement value data contained in the request message,
wherein the determining comprises determining at least one data editing function for the read additional data or for the received additional image data using the stored rule, performing the data editing function for the data requested in the request message, when the data editing function is performed, reading the data requested in the request message from a data store, and transmitting the edited data to the first data processing system.

4. The method as claimed in claim 1, wherein the storage comprises the storage of at least one rule that specifies the data editing function depending on an identifier that has been defined for a dataset or for a data object,
wherein the message specifies the identifier for the dataset or for the data object,
wherein in the determination, the determining comprises determining image data of at least one image, additional image data, measurement data, additional measurement data, or any combination thereof, and
wherein when the data editing function is performed, the data editing function is applied to the determined data, and
wherein when the data is determined, additional data contained in the message is used.

5. The method of claim 1, wherein the data editing function is performed in a picture archiving unit in which at least one image editing unit is integrated.

6. The method of claim 5, wherein the data editing function is defined in a dataset that is stored in the picture archiving unit.

7. The method of claim 6, wherein the picture archiving unit also communicates with imaging devices, the image data contains or is medical data, the measurement value data contains or is medical measurement value data.

8. The method of claim 2, wherein the additional image data or the additional measurement value data is structured according to the DICOM standard or a standard based thereon, the additional image data or the additional measurement value data is structured according to the EXIF standard or a standard based thereon, or the additional image data or the additional measurement value data is structured according to the HL7 standard or a standard based thereon.

9. The method of claim 1, wherein the additional image data or the additional measurement value data contain at least one, at least two or at least three of the following data:
a datum to indicate an identity of a patient;
a datum that indicates a day, a month, a year, or any combination thereof of the recording of the image data or the measurement value data;
a datum that indicates a clinical situation in connection with the image data;
a datum that indicates a nature, a type, a manufacturer, or any combination thereof of the recording device that has been used to record the image data or the measurement value data;
a datum that indicates a name, an address, an identifier, or any combination thereof of an institution recording the image data or the measurement value data;
a datum that indicates a focal length, an aperture setting, or a combination thereof in the recording of the image data;
a datum that indicates GPS data or other data for identifying the recording location of the image data or measurement value data; and
a datum that indicates a recording angle in the recording of the image data.

10. The method of claim 2, wherein the additional image data or a part of the additional image data transmitted jointly with the image data are transmitted separately from the image data in a message to a control unit that has access to the stored rules, or
wherein the additional measurement value data or a part of the additional measurement value data transmitted jointly with the measurement value data are transmitted separately from the measurement value data in a message to a control unit that has access to the stored rules.

11. The method of claim 2, wherein the determined additional image data or additional measurement value data or the additional image data or additional measurement value data contained in the request message are transmitted in a message to the control unit or another controller, which has access to the stored rules.

12. The method of claim 10, further comprising:
evaluating, by the control unit, the additional image data or additional measurement value data contained in the message using the stored rule or rules; and
generating, by the control unit, a further message for data editing unit, the further message containing an identifier to specify a data editing function, the additional data, or a combination thereof, wherein the control unit generates the further message with a time delay in relation to the first message.

13. The method of claim 1, wherein at least one message containing an identifier for a data editing function and command code for a data editing function is transmitted from the first data processing system to the second data processing system, and
wherein the identifier and the command code are stored in the data editing unit or another data editing unit.

14. The method of claim 1, wherein at least one message in which an identifier for at least one data editing function and at least one rule are specified is transmitted from the first data processing system to the second data processing system, the rule defining the condition under which the data editing function is to be performed depending on additional image data or additional measurement value data, or serving to establish whether a function specified in the rule is applicable to a dataset,
wherein the rule is stored such that a control unit has access to the rule, wherein the rule.

15. A data processing system or data processing system assembly comprising:
a data editing unit integrated into a picture archiving unit; and
a controller configured to access at least one rule, in which a condition, under which at least one editing function is to be carried out depending on image data or measurement value data, is specified, or that specifies a data editing function depending on an identifier that has been defined for a dataset or for a data object.

16. The method of claim 6, wherein the dataset is a dataset that meets the DICOM standard or the HL7 standard.

17. The method of claim 12, wherein the control unit generates the further message with a time delay greater than 5 minutes or greater than 30 minutes.

18. The method of claim 13, wherein the data editing function comprises an image editing function or a measurement value data editing function.

19. The method of claim 14, wherein the rule is stored in the control unit.
